(19) United States
(12) Patent Application Publication
(10) Pub. No.: US 2011/0241996 A1
(43) Pub. Date: Oct. 6, 2011

(54) STATE-DRIVEN SELF-SERVICE TERMINAL

(76) Inventor: Jan Vesely, Monifieth (GB)

(21) Appl. No.: 12/749,840

(22) Filed: Mar. 30, 2010

(51) Int. Cl. G06F 3/02

(52) U.S. Cl. 345/168

(57) ABSTRACT

A state-driven self-service terminal is described. The terminal comprises: (i) a state information table; (ii) a screen dictionary; (iii) a monitoring component arranged to ascertain status information relating to a condition of the terminal; and (iv) a screen control component. The screen dictionary comprises (a) a unique value corresponding to a unique key parameter, and (b) a control sequence including a prompt associated with that unique key parameter. The screen control component is arranged to receive the ascertained status information, and in response thereto, (a) to populate a screen with those prompts from the screen dictionary that are consistent with the ascertained status information and (b) to enable those keys corresponding to key parameters that are consistent with the status information.

### FIELD OF INVENTION

The present invention relates to a state-driven self-service terminal.

### BACKGROUND OF INVENTION

Self-service terminals, such as ATMs, can be controlled remotely using a host that downloads a transaction flow to the SST. NCR Corporation (trade mark) uses a proprietary message interface to allow a host to control an ATM. This proprietary message interface is called NCR Direct Connect (NDC). Other proprietary message interfaces are also available that enable a remote host to control an ATM. SSTs that are controlled remotely by a host (rather than by an application executing on the SST) are referred to herein as “state-driven SSTs”. As used herein, “state-driven SSTs” do not include any SST that uses a local application that is programmed with its own transaction flow. State-driven SSTs receive a transaction flow in the form of tables (including state, screen, and parameter information) downloaded from a remote host.

These proprietary message interfaces typically operate based on one or more tables of states and screens. When an ATM boots up, it downloads any necessary state and screen information (either the complete information or an update for existing information) from a control application executing on the remote host. The ATM can then offer transactions to a customer. Once the ATM has gathered the necessary details from the customer (card data, PIN data, transaction data, and the like), it then sends a transaction request to the remotely-located control application and receives a response. This response instructs the ATM to perform certain actions, such as dispensing a requested amount of cash if the transaction is authorized, or presenting a screen to the customer informing the customer that the transaction has not been approved, in the event that the transaction is declined.

Each ATM stores a state table, which typically comprises the state number, state type, parameters, configuration data, screen numbers, next state information, and screen data. In general, where a screen is present it is displayed when the state is entered, the ATM performs the action specified by the state type, and the transaction flow moves to the specified next state. Where a plurality of screens are defined for the same state, then each screen may be displayed in sequence prior to the ATM advancing to the next state.

One problem with state-driven ATMs is that the ATM does not know what it is presenting to the customer, all it knows is that it is presenting a predefined screen identified by a screen number (from the state table), and that it is enabling predefined Function Display Keys (FDKs) as indicated by the parameters (from the state table). If a screen being presented includes options that are not currently available, the ATM is not able to suppress presentation of these options because it does not know that they are being presented.

Furthermore, multiple screens may be required to cope with different possibilities. For example, one screen for a banknote deposit transaction may include an “Add more banknotes” option that can be displayed if a banknote escrow is not yet full, and an alternative screen for the banknote deposit transaction may not include the “Add more banknotes” option that can be displayed if the banknote escrow is full. The number and type of screens available are defined by the proprietary message interface, so extra screens cannot easily be added without updating the proprietary message interface.

It would be desirable to be able to make the screens more configurable without having to change the proprietary message interface.

### SUMMARY OF INVENTION

Accordingly, the invention generally provides methods, systems, apparatus, and software for an improved state-driven SST.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects of the invention may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a state-driven self-service terminal comprising:

(i) a state information table indicating a current state, an associated screen for display while the terminal is in that state, and key parameters for enabling customer inputs associated with options defined by the associated screen;

(ii) a screen dictionary comprising a plurality of entries, each entry including (a) a unique value corresponding to a unique key parameter, and (b) a control sequence including a prompt associated with that unique key parameter;

(iii) a monitoring component arranged to ascertain status information relating to a condition of the terminal; and

(iv) a screen control component arranged to receive the ascertained status information, and in response thereto, (a) to populate a screen with those prompts that are consistent with the ascertained status information and (b) to enable those keys corresponding to key parameters that are consistent with the status information.

By virtue of this aspect of the invention, the SST does not present a customer with any selectable prompts that are not relevant because of the status of an SST, nor does the SST enable any keys used for selecting any selectable prompts that are not relevant because of the status of an SST.

The monitoring component may be software, such as a runtime platform either alone or in combination with an application executing on the runtime platform.

The prompt may comprise graphics and/or a character string (such as text and/or numbers) that are to be presented on a display as a selectable option.

The prompt may correspond to a function defined by the state information table for that unique key parameter.

The key parameters may relate to Function Display Keys (FDKs) and/or keys on a keypad, such as an encrypting keypad.

The control sequence may further comprise position control values for the prompt for indicating a position on a screen at which the prompt is to be presented. When the screen control component populates a screen with only those prompts that are consistent with the ascertained status information, the screen control component may be further arranged to add each prompt to a position on the screen identified by its associated position control values, so that each prompt is adjacent to, and aligned with, an FDK corresponding to its respective key parameter.

The position control values may comprise two characters: a row reference character and a column reference character, indicating a row and column at which the prompt is to be displayed.

The control sequence may further comprise one or more format control values for the prompt, so that the format control values indicate how the prompt, or one or more parts of the prompt, should be displayed. For example, the format control values may indicate that the prompt is to be displayed in bold font, in large font, or the like.

The screen dictionary may be stored as part of the state information table, referenced by the state information table, or store separately from the state information table.

The terminal may comprise a plurality of screen dictionaries, each screen dictionary being associated with a screen.

The status information may relate to an event occurring at the terminal, a selection made by a customer at the terminal, a state of a device within the terminal, or the like.

As used herein, the term “screen” relates to data, not a physical device; and the term “display”, when used as a noun, refers to a physical device. Thus, a succession of screens can be presented (or rendered) on a display.

The self-service terminal may comprise an automated teller machine (ATM), an information kiosk, a financial services centre, a bill payment kiosk, a lottery kiosk, a postal services machine, a check-in and/or check-out terminal such as those used in the retail, hotel, car rental, gaming, healthcare, and airline industries, or the like.

According to a second aspect there is provided a method of operating a state-driven self-service terminal, the method comprising: (i) storing state information indicating (a) a current state, (b) an associated screen for display while the terminal is in that state, and (c) key parameters for enabling customer inputs associated with options defined by the associated screen; (ii) storing a screen dictionary comprising a plurality of entries, each entry having a unique value corresponding to a unique key parameter, and (b) a control sequence including a prompt associated with that unique key parameter; (iii) detecting status information relating to the terminal; (iv) populating a screen with only those prompts that are consistent with the detected status information; and (v) enabling only those keys corresponding to key parameters that are consistent with the status information.

The state information may indicate (b) a plurality of associated screens for display while the terminal is in that state.

The step of populating a screen with only those prompts that are consistent with the detected status information may further comprise superimposing those prompts onto the associated screen. The associated screen may include blank portions to facilitate this superimposition. Alternatively, the step of populating a screen with only those prompts that are consistent with the detected status information may further comprise creating a composite screen comprising the associated screen having portions thereof replaced by the prompts.

According to a third aspect there is provided computer readable media storing instructions which, when executed on a self-service terminal, implement the method of the second aspect.

The computer readable medium may comprise a magnetic drive, an optical disk, a computer memory, or the like.

According to a fourth aspect there is provided a network of self-service terminals, the network comprising a host including a control application, and a plurality of state-driven self-service terminals according to the first aspect.

The control application executing on the host may download the state information table to the plurality of SSTs. The state information table may be identical for each SST in the network.

For clarity and simplicity of description, not all combinations of elements provided in the aspects recited above have been set forth expressly. Notwithstanding this, the skilled person will directly and unambiguously recognize that unless it is not technically possible, or it is explicitly stated to the contrary, the consistory clauses referring to one aspect are intended to apply mutatis mutandis as optional features of every other aspect to which those consistory clauses could possibly relate.

These and other aspects will be apparent from the following specific description, given by way of example, with reference to the accompanying drawings.

### BRIEF DESCRIPTION OF THE DRAWINGS

FIG. 1 is simplified schematic diagram of a state-driven self-service terminal according to one embodiment of the present invention;

FIG. 2 is a schematic diagram showing a part (the customer display module) of the terminal of FIG. 1 in more detail;

FIG. 3 illustrates a simplified excerpt from a state information table stored in the terminal of FIG. 1;

FIG. 4 is a table describing part of an entry (the Cash Accept state and its associated parameters) in the state information table of FIG. 3 in more detail;

FIG. 5 is a table illustrating the contents of a first screen dictionary stored in the terminal of FIG. 1;

FIG. 6 is a table illustrating the contents of a second screen dictionary stored in the terminal of FIG. 1;

FIG. 7 is a pictorial diagram illustrating the customer display module of the terminal of FIG. 1 presenting a first screen having prompts inserted from the screen dictionary of FIG. 5; and

FIG. 8 is a pictorial diagram illustrating the customer display module of FIG. 6 presenting a variant of the first screen having prompts inserted from the screen dictionary of FIG. 6.

### DETAILED DESCRIPTION

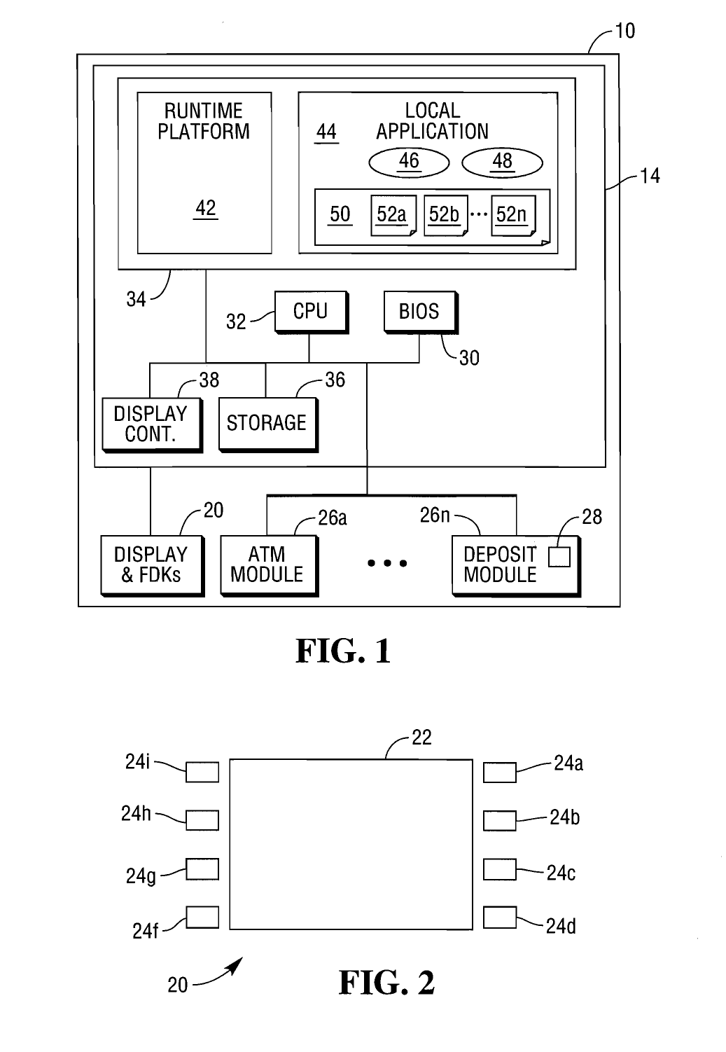

Reference is first made to FIG. 1, which is a simplified, schematic diagram of a state-driven self-service terminal (SST) 10, in the form of an automated teller machine (ATM), according to one embodiment of the present invention.

The ATM 10 comprises a plurality of modules for enabling transactions to be executed and recorded by the ATM 10. These ATM modules comprise: a controller module 14, a customer display module 20, and various other user interface modules and internal ATM modules (labeled 26a to 26n), which are not shown in detail. One of these modules is a depository module 26n having an escrow 28.

The controller 14 comprises a Basic Input Output System (BIOS) 30 stored in non-volatile memory, a microprocessor 32, main memory 34, storage 36 in the form of a magnetic disk drive, and a display controller 38 in the form of a graphics card for controlling the customer display module 20 and any operator panel (not shown) that is present.

As shown in more detail in FIG. 2, the customer display module 20 comprises an LCD display panel 22 and eight function display keys (FDKs) (labeled 24a to 24i—there is no 24e) arranged as two columns of four FDKs located opposite each other and on either vertical side of the front of the LCD display panel 22.

When the ATM is powered up, the main memory 34 is loaded with an ATM runtime platform 42 (which functions, inter alia, as a monitoring component) and a local application 44, both of which are stored on the magnetic disk drive 36.

The ATM runtime platform 42 includes: (i) components from a conventional operating system (in this embodiment, Windows XP (trademark), available from Microsoft Corporation (trade mark)), and (ii) proprietary components.

As is known in the art, the local application 44 (i) presents a sequence of screens on the ATM display module 20 to a customer at the ATM, (ii) collates information from the customer via the ATM modules 20,26 and the runtime platform 42 (for example, customer account information from a customer's ATM card, transaction request, transaction amount, and the like), (iii) transmits a transaction request to a remote authorization server (not shown), and (iv) instructs modules within the ATM 10, in response to commands received from the remote authorization server to fulfill the transaction request.

The local application 44 includes a message interface component 46, and a screen control component 48. The local application 44 also stores a state information table 50 (populated with data downloaded from a remote host), including a plurality of screen dictionaries 52a,b . . . n.

The message interface component 46 implements the NCR Direct Connect (NDC) message interface and enables the ATM 10 to communicate with a control application (not shown) executing on a remote authorization server (not shown).

The screen control component 48 communicates with the runtime platform 42 to receive status information. This status information includes customer selections at the ATM 10, the state of modules 26 within the ATM 10, events occurring within the modules 26 of the ATM 10, and the like.

The state information table 50 comprises the state number, state type, parameters, configuration data, screen numbers, next state information, and screen data. Although referred to herein as a state information table 50, this table 50 actually comprises a series of linked tables (for example, a card read table, a PIN entry table, a cash accept table, and the like), or a table with further tables nested therein. There is typically one or more table entries for each state type, plus other associated tables. The particular data structure that is chosen to store this state information is not critical.

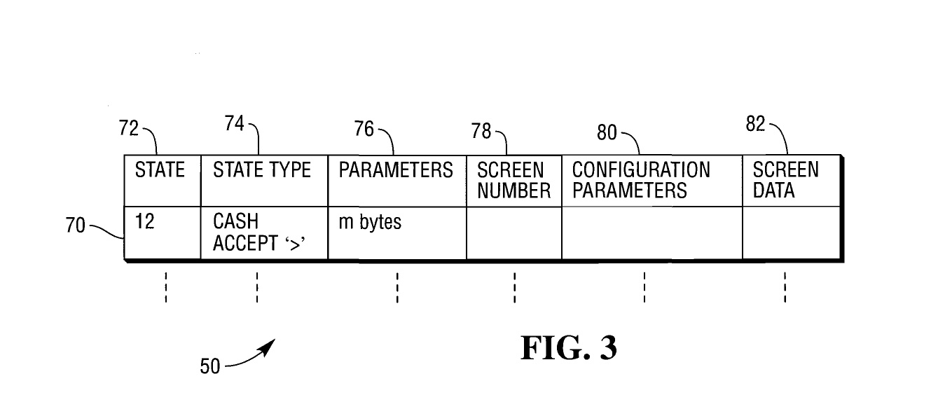

Reference will now be made to FIG. 3, which is a simplified excerpt from the state information table 50.

For illustration purposes, the state information table 50 is shown having only one entry 70 and six columns 72 to 82, although many more entries would exist in full embodiments.

The first column 72 is the State Number column. This is populated with a unique number for each state in the state information table 50. In this example, for entry 70, the state number is “12”.

The second column 74 is the State Type column. There are many possible state types, such as the Card Read state, the PIN Entry state, the Eight FDK state, the Close state, and the like. Each of these states has a unique identifier. For example, the Cash Accept state has the identifier “>”.

The third column 76 is the Parameters column. There are a number of parameters that can be used in this column 76, but the most important for the purpose of this embodiment are the key parameters that relate to which FDKs are to be enabled when the local application 44 is in the state for that entry 70 (which is state number 12 in this example).

The fourth column 78 is the Screen Number column. Each entry for this column includes a number corresponding to an associated screen.

The fifth column 80 is the configuration parameters, which relate to ATM configuration parameters, such as the length of time before a time-out is activated, the status messages used, and the like. These configuration parameters are conventional and not directly relevant to this embodiment.

The sixth column 82 is the Screen Data column. This column contains the screen data for the screen or screens to be presented on the customer display module 20 when the ATM 10 is in that state (which is state “12” for entry 70). The screen data for each screen also includes any screen dictionary 52 associated with that screen.

Although illustrated in FIG. 3 as a table, the state information may be stored as a series of tables, or in any other convenient manner, which is why there is a number in column four referencing the associated screen data, even though the actual screen data is illustrated as residing in column six.

The format of this state information table 50 is conventional and known to those of skill in the art.

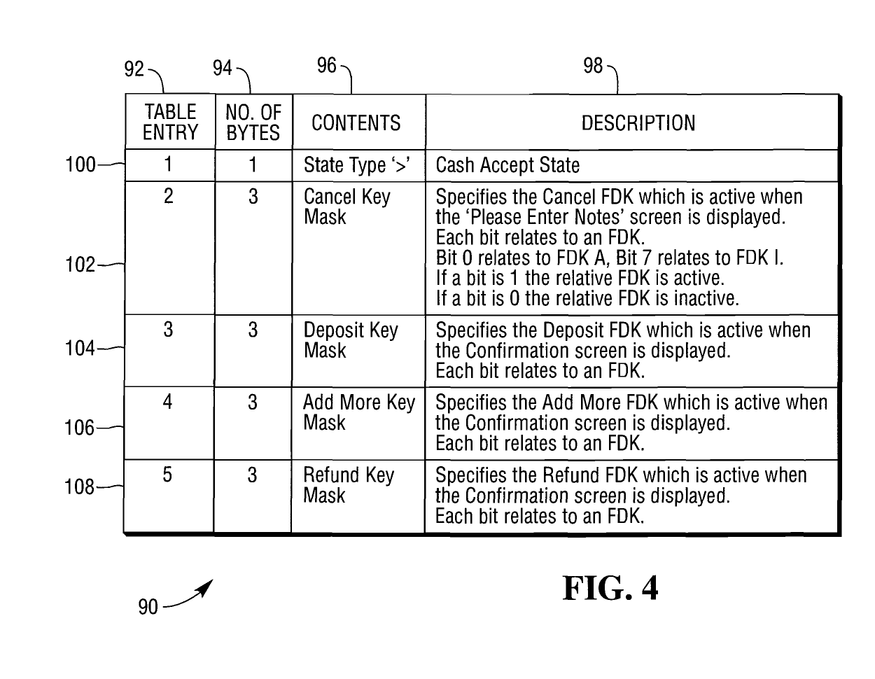

Part of entry 70 of the state information table 50 is shown in more detail in FIG. 4, which is a table 90 describing the Cash Accept state and its associated parameters in more detail. Although this part of entry 70 is shown in tabular form, it is in fact stored as an entry in the state information table 50, and this one entry is illustrated in tabular form in FIG. 4 only for clarity of explanation and to aid understanding.

The Cash Accept state table 90 comprises a table entry column 92 (which contains a unique entry number that is incremented for each entry), a number of bytes column 94 (which shows the number of bytes of data assigned to the contents for that entry), a contents column 96 (which describes the contents for that entry), and a description column 98 (which describes how to interpret the contents for that entry). Only the contents column 96 actually appears in the state information table 50; the other information is provided to aid understanding this embodiment.

The first entry 100 indicates that one byte is used to designate the state type. In FIG. 4, the state type indicated is the Cash Accept state. This appears in the state information table 50 in row 70 column 74 as “>” (which is the code used to indicate the Cash Accept state).

The second to fifth entries 102, 104, 106, 108, 110 are used to designate the key parameters (that is, the FDKs) that are used when the ATM 10 is in the Cash Accept state.

The Cash Accept state table 90 indicates that four FDKs should be enabled: a Cancel FDK (entry 102), a Deposit FDK (entry 104), an Add More FDK (entry 106), and a Refund FDK (entry 108). Each of these four key parameters comprises three bytes that indicate which FDK on the ATM 10 is to be enabled for its defined function (Cancel, Deposit, Add More, and Refund). If the first bit is active and the remaining seven bits inactive, then the first FDK (24a) is to be enabled. If the second bit is active and the remaining seven bits (bit one and bits three to eight) are inactive then the second FDK (24b) is to be enabled. If the fifth bit is active and the remaining seven bits (bits one to four and bits six to eight) are inactive then the fifth FDK (24f) is to be enabled, and so on. It is also possible that multiple FDKs may be enabled for the same function; for example, if the first and second bits are both enabled, then the first (24a) and second (24b) FDKs are both enabled for the same function (for example, “Cancel”).

The data from column 94 and rows 102 to 108 appears in the state information table 50 in row 70 column 76 as a sequence of “m” bytes. Although only twelve bytes are illustrated for column 94 and rows 102 to 108, there are other bytes that are included in row 70 column 76 in addition to these twelve bytes, but these additional bytes are not relevant to this example. Furthermore, different state types may use a different number of parameters.

The second entry 102 in the Cash Accept state table 90 relates to an FDK that is enabled when a “Please Enter Notes” screen is presented on the customer display module 20; whereas, the third to fifth entries 104, 106, 108 relate to FDKs that are enabled when a “Confirmation” screen is presented on the customer display module 20. There are other screens defined by the message interface for this state that are not referenced above, such as a “Please Wait” screen and an “Error” screen. Another screen defined for this state by the message interface is an “Escrow Full” screen, which is used when the escrow 28 cannot accommodate any more banknotes. These defined screens are stored in the Screen Data column 82 of the state information table 50.

It will be appreciated that the Cash Accept state table 90 is provided to give a human programmer an understanding of the meaning of the data structures used. The ATM 10 uses a sequence of bits as indicated in the number of bytes column 94 because the ATM 10 is aware that the first byte relates to the state type, the next three bytes relate to the Cancel FDK, the next three bytes relate to the Deposit FDK and the like.

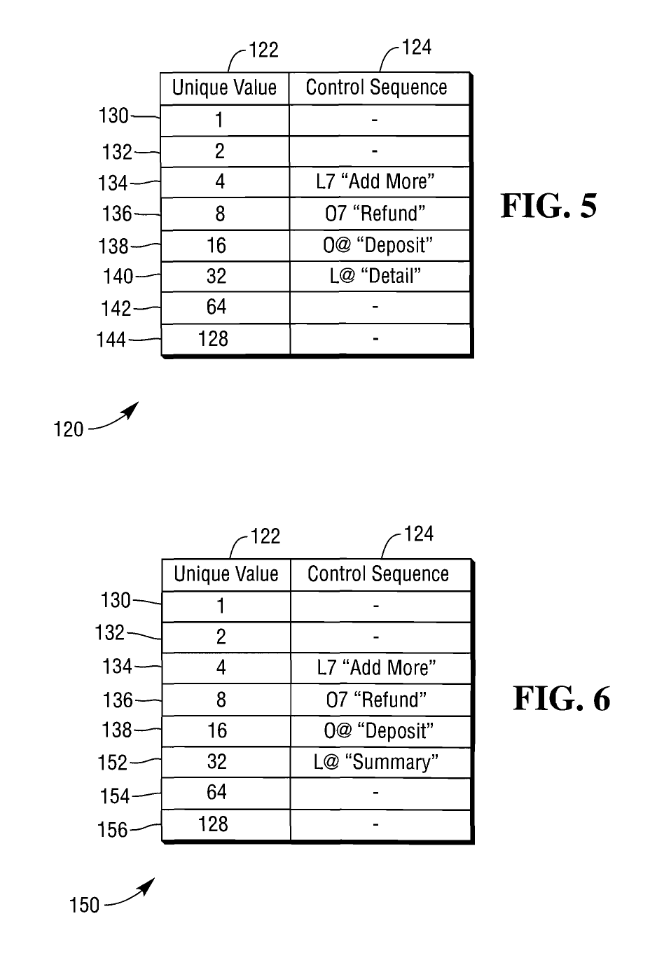

Reference will now be made to FIG. 5, which is a table 120 illustrating a screen dictionary 52a for the Confirmation screen. This screen dictionary 52a is assigned a unique identification (in this example, “999”). One reason that the Confirmation screen dictionary 52a is given a unique identification is that there may be multiple screens for each state, and each screen may have its own screen dictionary 52, or even multiple screen dictionaries. Each screen dictionary 52 has an entry for each FDK (or other key) that is to be enabled while that screen is presented. If any screen does not have an associated screen dictionary, then the settings for that screen are used as normal. In other words, a screen dictionary is not essential; where one is not present, the globally-configured screen parameters are used.

The Confirmation screen dictionary table 120 comprises two columns and nine rows. The first column (the identification column) 122 stores a unique identifier corresponding to one of the eight FDKs, and the second column (the prompt column) 124 stores a control sequence.

The control sequence includes a prompt comprising text or graphics that is to be presented on a screen if the FDK corresponding to that prompt is enabled. The control sequence also includes position control values indicating where on a screen the prompt is to be displayed, and optionally format control values indicating how the text is to be presented (for example, as bold, italics, or normal font).

In this embodiment, the unique identifier is the equivalent value for the FDK code used in the number of bytes column 94. For example, if the Add More FDK (entry 106 in the Cash Accept state table 90) is assigned to the third FDK 24c, then the associated entry in the Parameters column 76 (state information table 50) would be “00000100”, which is the value “4”. This value would then be used as the unique identifier in the screen dictionary table 120 (column 122). This provides a simple and direct way to link the FDKs defined in the state information table 50 with the prompts stored in the screen dictionary 52.

Each of the row entries 130 to 144 in the Confirmation screen dictionary table 120 relates to a text prompt that can be displayed on the Confirmation screen.

In this example, a plurality of screens that can be displayed in the Cash Accept state (the exact number is defined by the message interface using the state information table 50), one screen is a “Please Enter Notes” screen, another screen is a “Confirmation” screen, a third screen is an “Escrow Full” screen.

As will be described in detail below, this embodiment allows the “Escrow Full” screen to be used for a different purpose without changing the message interface (that is, without having to change the software resident on the remote authorization server).

The Escrow Full screen has an associated screen dictionary (the Escrow Full screen dictionary 52b), which is illustrated in FIG. 6 as a table 150. The Escrow Full screen dictionary 52b is assigned a unique identification (in this example, “998”). Those entries in table 150 that are identical to the corresponding entries in table 120 have common reference numerals. The only difference between the entries in the two tables 120,150 is that entry 152 relates to a “Summary” option; whereas, entry 140 (which relates to the corresponding FDK) relates to a “Detail” option.

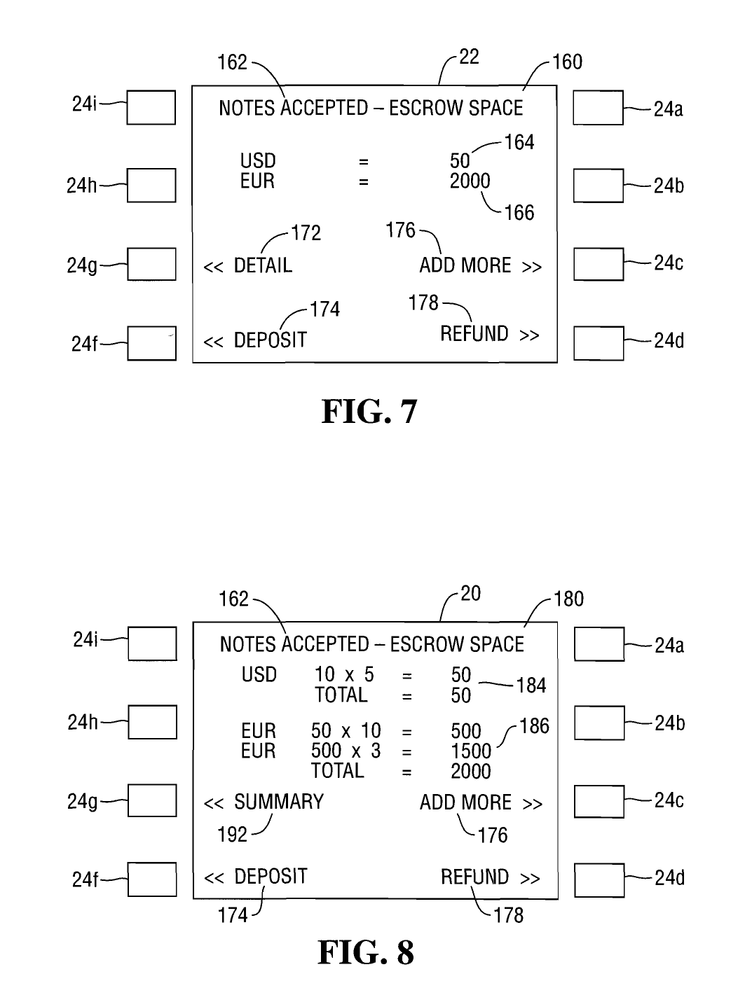

Reference will now also be made to FIG. 7, which is a pictorial diagram illustrating the customer display module 20 showing a Confirmation screen 160 during a transaction.

At this point in the transaction, a customer has been identified and has deposited banknotes into the depository module 26n in the ATM 10. The confirmation screen 160 comprises a fixed banner heading 162, a first currency deposit amount 164, a second currency deposit amount 166, and four locally-enabled FDK prompts 172 to 178.

The fixed banner heading 162 states “Notes Accepted—Escrow Space” indicating that banknotes have been accepted into the escrow 28 of the depository module 26n.

The first currency deposit amount 164 is presented in response to the escrow communicating the number of U.S. dollars deposited therein; and the second currency deposit amount 166 is presented in response to the escrow communicating the number of Euros deposited therein.

The four locally-enabled FDK prompts 172 to 178 are presented in response to the screen control component 48 querying the Confirmation screen dictionary 52a, as will now be described.

When the screen control component 48 populates the Confirmation screen 160, the screen control component 48 analyses the state information table 50 to ascertain which FDKs should be enabled and whether the Confirmation screen dictionary 52a should also be referred to.

If the Confirmation screen dictionary 52a does not need to be referred to, then the screen control component 48 populates the Confirmation screen 150 based on information from the relevant ATM module (in this example the depository, which is not shown) and the state information table 50. However, in this example, the Confirmation screen dictionary 52a must be referred to because its unique identification is referenced in the screen data.

By referring to the Confirmation screen dictionary 52a, the screen control component 48 can match text prompts corresponding to FDKs listed in the Confirmation screen dictionary 52a with FDKs defined by the state information table 50 (since the unique value in column 122 matches the byte pattern for the associated FDK). This enables the screen control component 48 to add the text for a prompt from the Confirmation screen dictionary 52a to the Confirmation screen 150 using the position information encoded by the position control values (from column 124) for that text. For example, because the state information table 50 lists the Add More FDK as enabled for the Confirmation screen 150, the screen control component 48 can add text relating to this prompt from column 124 row 134 of the Confirmation screen dictionary table 120.

One feature of this embodiment is that by locally enabling or disabling prompts for FDKs that are globally enabled by the state information table 50, it is possible to use a single screen having different configurations (or variants) rather than needing multiple different screens to be defined by the state information table 50. For example, in FIG. 7 the screen control component 48 has locally-enabled FDK 24c and presented the text “Add More” on the Confirmation screen 160 because the runtime platform 42 detected that the escrow 28 was not full and communicated this to the screen control component 48. If the escrow 28 was full, then the screen control component 48 would have locally disabled the FDK 24c and not displayed the “Add More” text, even though this FDK 24c is globally enabled by the key parameters in the state information table 50.

Furthermore, in this embodiment the Escrow Full screen can be reused for a different purpose, as will now be described with reference to the Escrow Full screen dictionary 52b as illustrated in FIG. 6, and also FIGS. 7 and 8.

In FIG. 7, the screen control component 48 has locally-enabled and locally-configured the FDK 24g and added prompt 162 to allow the customer to request details about the banknotes currently deposited in the escrow 28. If the customer selects this “Detail” option (by pressing FDK 24g) then the local application 44 remains in the same state (with reference to the state information table 50), but a variant screen is populated having prompts inserted from the Escrow Full screen dictionary 52b, as illustrated in FIG. 8.

FIG. 8 is a pictorial diagram of the customer display module 20 presenting the Detail Confirmation screen 180 (which the message interface has defined as the Escrow Full screen, but which is now being used as the Detail Confirmation screen 180).

The Detail Confirmation screen 180 comprises a fixed banner heading 162 (identical to that for the Confirmation screen 160), a first currency deposit amount in detail 184 (obtained from the escrow 28), a second currency deposit amount in detail 186 (also obtained from the escrow 28), and four locally-enabled FDK prompts 174, 176, 178, and 192.

Three of these locally-enabled FDK prompts 174, 176, 178 are identical to those presented on the Confirmation screen 160. The fourth FDK prompt (the Summary prompt 192) was populated by the screen control component 48 from entry 152 of the Escrow Full screen dictionary 52b (table 150).

The Summary prompt 192 is presented at the same location as the Detail prompt because the position control values (“9A”) from the control sequence (prompt column 124) of the Escrow Full screen dictionary 52b is the same as the position control values (“9A”) from the control sequence (prompt column 124) of the Confirmation screen dictionary 52a.

It should now be appreciated that this embodiment allows multiple variants of a single screen to be presented based on the contents of one or more screen dictionaries 52 and the state of the ATM 10 (for example, a customer selection, a module condition, a module event, or the like).

By providing one or more screen dictionaries 52 it is possible to enable or disable on a local basis those FDKs that are globally enabled by the state information table 50. It is also possible to populate a screen with different text prompts defined by the screen dictionaries 52 since the ATM 10 can ascertain which prompts relate to which FDKs and what those prompts refer to.

Various modifications may be made to the above described embodiment within the scope of the invention, for example, in other embodiments the prompts may comprise graphics instead of or in addition to text.

The state information table 50 may be arranged in any convenient data structure or format, for example, as a single table, a group of tables, a list, or the like.

The screen dictionaries 52 may be defined in any convenient manner using any convenient data structure format.

The steps of the methods described herein may be carried out in any suitable order, or simultaneously where appropriate. The methods described herein may be performed by software in machine readable form on a tangible storage medium or as a propagating signal.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

Unless otherwise indicated by the context, the terms “a” and “an” are used herein to denote at least one of the elements, integers, steps, features, operations, or components mentioned thereafter, but do not exclude additional elements, integers, steps, features, operations, or components.

What is claimed is:

1. A state-driven self-service terminal comprising:
(i) a state information table indicating a current state, an associated screen for display while the terminal is in that state, and key parameters for enabling customer inputs associated with options defined by the associated screen;
(ii) a screen dictionary comprising a plurality of entries, each entry including (a) a unique value corresponding to a unique key parameter, and (b) a control sequence including a prompt associated with that unique key parameter;
(iii) a monitoring component arranged to ascertain status information relating to a condition of the terminal; and
(iv) a screen control component arranged to receive the ascertained status information, and in response thereto, (a) to populate a screen with those prompts that are consistent with the ascertained status information and (b) to enable those keys corresponding to key parameters that are consistent with the status information.

2. A terminal according to claim 1, wherein the monitoring component comprises a runtime platform in combination with an application executing on the runtime platform.

3. A terminal according to claim 1, wherein the prompt comprises text that is to be presented on a display as a selectable option.

4. A terminal according to claim 1, wherein the key parameters may relate to Function Display Keys (FDKs).

5. A terminal according to claim 1, wherein the status information relates to an event occurring at the terminal, a selection made by a customer at the terminal, or a state of a device within the terminal.

6. A terminal according to claim 1, wherein the control sequence further comprises a position control value for indicating a position on a screen at which the prompt is to be rendered.

7. A terminal according to claim 1, wherein the self-service terminal comprises an automated teller machine (ATM).

8. A network of self-service terminals, the network comprising a host including a control application, and a plurality of state-driven self-service terminals according to claim 1.

9. A method of operating a state-driven self-service terminal, the method comprising:
(i) storing state information indicating (a) a current state, (b) an associated screen for display while the terminal is in that state, and (c) key parameters for enabling customer inputs associated with options defined by the associated screen;
(ii) storing a screen dictionary comprising a plurality of entries, each entry having (a) a unique value corresponding to a unique key parameter, and (b) a control sequence including a prompt associated with that unique key parameter;
(iii) detecting status information relating to the terminal;
(iv) populating a screen with only those prompts that are consistent with the detected status information; and
(v) enabling only those keys corresponding to key parameters that are consistent with the status information.

10. A computer readable medium storing instructions which, when executed on a self-service terminal, implement the method of claim 9.

11. A computer readable medium according to claim 10, wherein the medium comprises computer memory.
